(19) United States
(12) Patent Application Publication
(10) Pub. No.: US 2009/0166346 A1
(43) Pub. Date: Jul. 2, 2009

(54) Method and Device for Producing a Bond of Components

(76) Inventors: Udo Ketelhut, Stade (DE); Manfred Hansen, Jork (DE); Berend Andreessen, Stade (DE); Wolfgang Ende, Neuwulmstorf (DE)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/087,095

(22) PCT Filed: Jan. 4, 2007
(86) PCT No.: PCT/EP2007/050096

§ 371 Date: Nov. 12, 2008

Related U.S. Application Data
(60) Provisional application No. 60/779,208, filed on Mar. 3, 2006.

(30) Foreign Application Priority Data
Jan. 11, 2006 (DE) 10 2006 001 494.4

(51) Int. Cl. B23K 11/00

(52) U.S. Cl. 219/148

(57) ABSTRACT

The invention relates to a method for producing a bond of a first component (2) and of a second component (3) by means of a connecting mass (4), in particular with regard to large-area aircraft components of cylindrical or spherical contour, with the following method steps: (S1) connection of the components (2, 3) by means of the connecting mass (4); (S2) application of a heating element (6) to the first component (2); and (S3) curing of the connecting mass (4) by heating by means of the heating element (6) to produce the bond of the components (2, 3), wherein, during the curing of the connecting mass (4), a force is applied to the heating element (6) and the components (2, 3) by means of a first covering element (8) in the form of a vacuum film by the evacuation of a first cavity (12) in which the components (2, 3) and the heating element (6) applied to them are arranged, and to a corresponding device (1).

The invention relates to a method for producing a bond of a first component and of a second component by means of a connecting mass, in particular with regard to large-area aircraft components of cylindrical or spherical contour, and to a corresponding device.

Such large-area aircraft components are applied, for example, to parts of the outer skin of an aircraft fuselage or to parts of control members, for example, landing flaps, in order to provide sliding surfaces for movable components with respect to other stationary or even movable components. Where landing flaps are concerned, such sliding surfaces are called anti-scuff plates which form defined wearing zones and thus protect the associated components against uncontrolled wear.

In the case of an aircraft, when the aircraft is in operation, all the external components are exposed to flow actions of the surrounding atmosphere and, when attached at a later stage, must be firmly connected correspondingly to the respective component to which they are applied, and must, in this respect fulfil relevant safety regulations. This applies particularly to the anti-scuff plates on the surfaces of landing flaps, which, only in specific operating states of the aircraft, are extended so as to vary the lift coefficient of the airfoils, for example, during starting and landing, and which in this case penetrate into the flow of the airfoil, corresponding forces which are brought about by the flow acting on the landing flaps and on the anti-scuff plates fastened to them.

At the present time, such anti-scuff elements in plate form with small thickness are assembled, according to specific instructions, together with the associated components in a prescribed manufacturing sequence. This takes place by means of an adhesive, what is known as a sealant. For this purpose, the adhesion surfaces of the two components to be connected are cleaned. Thereupon, an adhesion promoter is applied, this being followed by the application of the sealant. The component to be attached is applied to this adhesive, oriented and fixed since the adhesive requires a specific time in order to cure completely. At the same time, a force is applied to the components to be connected, which is normally generated by means of a vacuum under a vacuum film which is arranged sealingly over the anti-scuff plate and the surrounding region of the surface of the flap. This vacuum technology is customary in this context, since aircraft components have curved surfaces, for example of cylindrical or spherical contour, the vacuum film suitably mating with these surface profiles and thus exerting a force. To protect the vacuum film and the protective plate, a protective fleece is arranged between these. After the vacuum is generated, a waiting time for curing of 14 to 16 hours at uniform temperature, for example, 23° C.±2° C., is required.

What has proved a disadvantage in this case is that, particularly in maintenance work, to exchange worn anti-scuff plates, because of the long curing time of the sealant, the entire aircraft has to remain at room temperature in a hangar of corresponding size which must maintain a constant temperature. It has been shown that this required constancy is destroyed even when a hangar door is opened, temperature drops of for example 5° C. resulting in a doubling of the curing time. This makes the throughput of aircraft to be maintained considerably slower. Moreover, a heatable hangar with a defined regulatable temperature is required.

A further disadvantage is that, during the long curing time, the vacuum pumps necessary for generating the vacuum require corresponding electrical power and also frequent maintenance.

The object of the invention, therefore, is to improve the method, as compared with the prior art, the abovementioned disadvantages being reduced or eliminated.

A further object of the invention is to provide a corresponding device for the method according to the invention.

The object of the invention is achieved by means of a method according to Claim 1 and a device according to Claim 7.

The essence of the invention is to carry out an integration of heating elements in the immediate vicinity of the components to be attached. This affords the significant advantage of a reduction in the curing time of the adhesive to three to four hours, this being a quarter of the time involved in the prior art.

A method according to the invention for producing a bond of a first component and of a second component by means of a connecting mass, in particular with regard to large-area aircraft components of cylindrical or spherical contour, has the following method steps:
(S1) connection of the components by means of the connecting mass;
(S2) application of a heating element to the first component; and
(S3) curing of the connecting mass by heating by means of the heating element to produce the bond of the components;
   during the curing of the connecting mass, wherein, a force is applied to the heating element and the components by means of a first covering element in the form of a vacuum film by the evacuation of a first cavity in which the components and the heating element applied to them are arranged.

By means of the heating element, it is possible to keep the temperature optimal for curing the adhesive, that is to say the connecting mass, constant in locally limited surroundings independently of the location of the aircraft or of the components or independently of surrounding influences. This advantageously affords a curing time which is reduced, as compared with the prior art. Since the heating element is an electrical heating film, it has the advantage that it can easily be adapted to the various forms and configurations of the components.

In a preferred embodiment, there is provision for the first cavity to be formed by the first covering element and a surface of the second component, the first covering element covering the heating element and the components completely and being sealingly connected with the surface by a sealing element.

In a further preferred version, the heating of the connecting mass takes place by means of the heating element at a constant temperature preferably regulated by means of a regulating device which is connected to at least one temperature sensor arranged in the region of the heating element.

To protect the heating element, it is expedient that, during the application of the heating element, a first protective element is arranged between its underside and the top side of the first component, and a second protective element is arranged on the top side of the heating element for the mechanical protection of the heating element. This affords the advantage that, on the one hand, the heating element can be used again and there is no need for a sealing mass to be cleaned off from it, since the protective elements offer protection, on the one hand against soiling and also against damage to the heating element.

In a further embodiment, there is provision, in the method step of curing the connecting mass, for a second covering element to be arranged above the first covering element for heat insulation. Such a covering hood can, in a suitable dimensioning and form, improve temperature constancy for curing particularly in exposed surroundings, whilst, even during normal use, an advantage in terms of energy saving is to be noted.

A device according to the invention for carrying out the above-described method according to the invention has the following:
at least one heating element in the form of an electrical heating film for heating the connecting mass;
at least one temperature sensor for detecting the actual temperature of the heating element;
a regulating device for the temperature of the heating element;
a first and second protective element for the mechanical protection of the heating element; and
a means for applying a force to the heating element and the components by means of a first covering element in the form of a vacuum film by the evacuation of a first cavity in which the components and the heating element applied to them are arranged.

The temperature sensors may be mounted below the heating element between its underside and the first component. In this case, it is advantageous if these are flat sensors which do not impair the surface of the first component. The temperature sensors may also be arranged elsewhere, the regulating device advantageously making it possible to incorporate different measurement locations into its regulating algorithm.

In this case, it is preferred that the first cavity is formed by the first covering element and a surface of the second component, the first covering element covering the heating element and the components completely and being sealingly connected with the surface by a sealing element.

In a further preferred version, the heating element has a carrier layer which forms mechanical protection. In this case, in one embodiment of the carrier layer, a protective element may be dispensed with if the carrier layer is designed with its protective action.

It is particularly advantageous that at least one temperature sensor is integrated in the heating element, since installation work for the sensors is thus simplified and is restricted only to wiring up to the regulating device.

In another version, the heating element has a cover layer which at the same time is designed for heat insulation. Heat losses, even at the source are thus avoided. It is particularly advantageous if this cover layer additionally reflects heat radiation.

In a further version, the device has a second covering element for heat insulation, which may be arranged above the device in an advantageously simple way. Further energy losses are consequently avoided.

An exemplary embodiment of the invention is illustrated by way of example in the accompanying diagrammatic drawings in which:

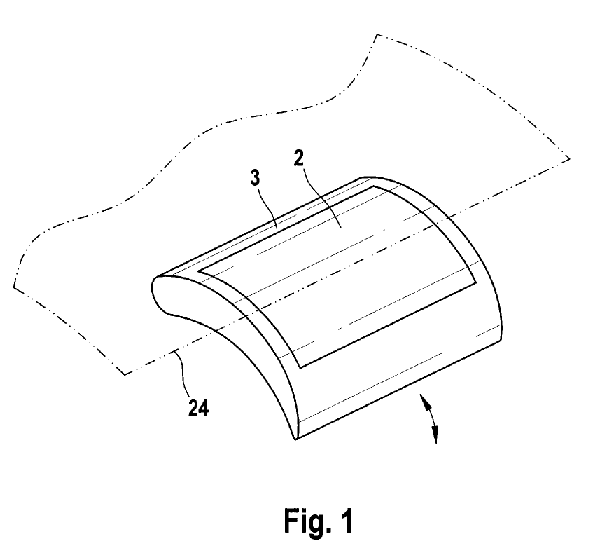

FIG. 1 shows a diagrammatic view of a landing flap with scuff protection;

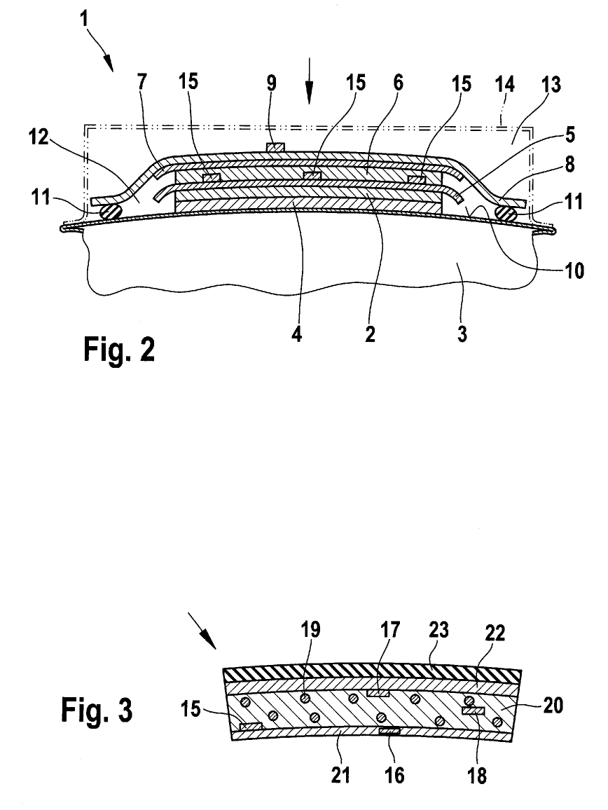

FIG. 2 shows a diagrammatic sectional illustration of an exemplary embodiment of the device according to the invention; and

FIG. 3 shows a diagrammatic sectional illustration of a heating element.

Identical or functionally identical elements are given the same reference symbols in the figures, unless specified otherwise.

FIG. 1 illustrates diagrammatically a landing flap as a second component 3 of an aircraft, not shown. An anti-scuff plate is attached as a first component 2 to the surface of the second component 3 and forms a defined sliding and wearing surface of the landing flap with respect to an airfoil 24 indicated by dashes. The landing flap is shown in a middle position, and it can be positioned in a retracted position below the airfoil 24 and in a completely extended position outside the airfoil 24. Its movement is indicated by an arrow. When the aircraft is in operation, relative movements of the landing flap with respect to movements of the airfoil 24 lead to contacts between the airfoil underside and the anti-scuff plate. Such an anti-scuff plate may also be attached to the underside of the landing flap or elsewhere.

The attachment of such a first component 2 to the second component 3 is carried out by means of a device 1 which is shown in FIG. 2 in a diagrammatic sectional illustration together with the components 2 and 3 to be bonded together. In this case, the proportions of the dimensions are not adhered to, the thicknesses of the individual layers being shown, substantially enlarged, for the sake of clarity.

A connecting mass 4, on which the second component 2 is located, is applied to the second component 3, which here may be the landing flap or else another aircraft component, on the surface 10 of the second component 3. On the top side of the second component 2 lies a first protective element 5 on which a heating element 6 is arranged. In this exemplary embodiment, the heating element 6 is equipped with temperature sensors 15 which are located within the heating element 6. The heating element 6 is discussed in more detail below.

The top side of the heating element 6 is provided with a second protective element 7, above which is arranged a first covering element 8 which completely covers the arrangement of the first component 2 with the heating element 6 and the protective elements 5 and 7 and which is sealingly fastened continuously (not illustrated) with its sides on the surface 10 of the second component 3. Sealing-off is ensured by means of a continuous sealing element 11. A first cavity 12 is thereby formed which extends around the arrangement described and which is connected to a connection 9 which is introduced in the first covering element 8.

The method according to the invention is now described with reference to FIG. 2, the functions of the individual elements also being explained.

After the customary cleaning of the adhesion surfaces, that is to say the underside of the first component 2 and the corresponding region of the surface 10 of the second component 3, these adhesion surfaces are provided with an adhesion promoter. The connecting mass 4 is then applied to the adhesion surface of the second component 3, and the first component 2 is attached to it, positioned and fixed. The connecting mass 4 is an adhesive or what is known as a sealing compound which has a specific curing time.

The first protective element 5 is laid onto the first component 2 and protects the heating element 6 arranged on it against soiling by sealing compound. The heating element 6 may be used again and therefore does not have to be cleaned additionally for re-use. The second protective element 7, what is known as an airweave, is then arranged as a protective fleece on the heating element 6 and forms a uniform transition to the covering element 8.

The covering element 8 is designed in this case as a vacuum film with an introduced connection 9 for a vacuum pump, not illustrated.

The temperature sensors 15 integrated in the heating element 6 which is an electrical heating film are connected to a regulating device, not shown, the output of which is connected to the electrical connections, likewise not shown, of the heating element 6. The regulating device can be set to a desired temperature which corresponds to an optimal curing temperature of the connecting mass 4. The actual temperature is detected by the temperature sensors 15 and is transmitted to the regulating device which keeps the temperature generated by the heating element 6 constant according to the desired temperature. Different installation locations of the temperature sensors 15 can be compensated by means of a corresponding setting of the regulating device. Overshooting the maximum permissible temperature in the connecting mass 4 is prevented by the regulating device.

To apply a force to the arrangement, the connection 9 is connected to a vacuum pump (not shown) which evacuates the first cavity 12 and which thus via the generated vacuum exerts, by means of the vacuum film 8, a uniform pressure force on the heating element 6 and therefore on the components 2 and 3 to be bonded together.

The heating element 6 is designed as a film resistant to high pressure. Tests with this arrangement have shown that a very good distribution of the connecting mass 4 between the components 2 and 3 is achieved. This is of great importance, since the first component 2 has a small thickness of only 0.2 mm. It is in this example a plate consisting of high-grade steel. Creases in the vacuum film or in the connection 9 arranged above the second component 2 may lead to damage to the first component 2. However, this arrangement allows clear observation in order to prevent creasing.

The heating element 6 is shown diagrammatically in a section in FIG. 3 in a further exemplary embodiment. It consists of a carrier layer 21 to which is applied a heating layer 20 which is provided with a cover layer 22. Within the heating layer 20 is arranged an electrical heating, not explained any further. Temperature sensors are illustrated here at various points. These may be integrated in greater or lesser number in the heating film. For example, a first temperature sensor 15 is arranged in the heating layer 20 on the inside of the carrier layer 21. A second temperature sensor 16 is arranged within the carrier layer, a third temperature sensor 18 is arranged within the heating layer 20 and a fourth temperature sensor 17 is arranged below the cover layer 22 in the heating layer 20. It is advantageous if the temperature sensors are designed in a flat version, in order to avoid damage to the first component 2, as explained above.

The heating element 6 according to FIG. 3 has a further particular feature in that the cover layer 22 is provided with an insulating layer 23 for heat insulation. This insulating layer 23 may also be designed for the reflection of heat radiation, with the result that energy can be saved.

Since the second component 3 is often a composite material part with low heat conduction, this method is particularly energy-saving, since the heat introduced into the connecting mass 4 is not dissipated via the second component 3 excessively rapidly.

By means of the device 1 according to the invention and the method capable of being carried out thereby, it is possible to reduce the manufacturing time of the arrangement to 3 to 4 hours instead of 14 to 16 hours. The manufacturing sequence in production and during maintenance or repair work is accelerated considerably. A time saving of 70 to 80% is afforded.

Since the temperature is applied in the immediate vicinity of the connecting mass 4 to be cured, this operation is independent of surrounding conditions. That is to say, an aircraft does not have to be drawn into a hangar for this processing work. Moreover, in the event of processing in the hangar, the hangar temperature can be lowered from 23° C. to a customary 18 . . . 20° C., thus resulting in further savings.

The invention is not restricted to the example explained, numerous modifications are possible within the scope of the accompanying claims.

Thus, for example, the carrier layer 21 may consist of different materials which either do not necessitate a first protective element 5 or else possess additional heat-conducting properties. A preferred material in this example is Kapton, but also Teflon and others are possible.

The application of the force may take place by other suitable means.

The temperature sensors may also be designed in film form and/or be integrated, for example, in the first protective element 5.

For additional heat insulation when the method is employed in unfavourable surroundings, for example, outside hangars, and for protection against environmental influences, a second covering element 14 may be applied above the arrangement of the device 1.

The first protective element 5 may also be designed as overheating protection against an overshooting of the maximum permissible temperature of the connecting mass 4, in that it damps an immediate heat transition in the event of temperature fluctuations, for example during the heating of the heating element 6.

### LIST OF REFERENCE SYMBOLS

1 Device
2 First component
3 Second component
4 Connecting element
5 First protective element
6 Heating element
7 Second protective element
8 First covering element
9 Connection
10 Surface
11 Sealing element
12 First cavity
13 Second cavity
14 Second covering element
15 First temperature sensor
16 Second temperature sensor
17 Third temperature sensor
18 Fourth temperature sensor
19 Heating
20 Heating layer
21 Carrier layer
22 Cover layer
23 Insulating layer
24 Airfoil
S1 . . . 3 Method step

1. Method for producing a bond of a first component (2) and of a second component (3) by means of a connecting mass (4), in particular with regard to large-area aircraft components of cylindrical or spherical contour, with the following method steps:
(S1) connecting the components (2, 3) by means of the connecting mass (4);
(S2) application of a heating element (6) in the form of an electrical heating film to the first component (2); and
(S3) curing of the connecting mass (4) by heating by means of the heating element (6) to produce the bond of the components (2, 3),
wherein, during the curing of the connecting mass (4), a force is applied to the heating element (6) and the components (2, 3) by means of a first covering element (8) in the form of a vacuum film by the evacuation of a first cavity (12) in which the components (2, 3) and the heating element (6) applied to them are arranged.

2. Method according to claim 1, characterized in that the first cavity (12) is formed by the first covering element (8) and a surface (10) of the second component (3), the first covering element (8) covering the heating element (6) and the components (2, 3) completely and being sealingly connected with the surface (10) by a sealing element (11).

3. Method according to claim 1 or 2, characterized in that the heating of the connecting mass (4) takes place by means of the heating element (6) at a constant temperature.

4. Method according to claim 3, characterized in that the temperature is regulated by means of a regulating device which is connected to at least one temperature sensor (15, 16, 17, 18) arranged in the region of the heating element (6).

5. Method according to one of claims 1 to 4, characterized in that, during the application of the heating element (6), a first protective element (5) is arranged between its underside and the top side of the first component (2), and a second protective element (7) is arranged between the top side of the heating element (6) and the underside of the first covering element (8) for the mechanical protection of the heating element (6).

6. Method according to one of claims 1 to 5, characterized in that, in the method step of curing the connecting mass (4), a second covering element (14) is arranged above the first covering element (8) for heat insulation.

7. Device (1) for carrying out the method according to one of claims 1 to 6, which has the following:
at least one heating element (6) in the form of an electrical heating film for heating the connecting mass (4);
at least one temperature sensor (15, 16, 17, 18) for detecting the actual temperature of the heating element (6);
a regulating device for the temperature of the heating element (6);
a first and second protective element (5, 7) for the mechanical protection of the heating element (6); and
a means for applying a force to the heating element (6) and the components (2, 3) by means of a first covering element (8) in the form of a vacuum film by the evacuation of a first cavity (12) in which the components (2, 3) and the heating elements (6) applied to them are arranged.

8. Device (1) according to claim 7, characterized in that the first cavity (12) is formed by the first covering element (8) and a surface (10) of the second component (3), the first covering element (8) covering the heating element (6) and the components (2, 3) completely and being sealingly connected with the surface (10) by a sealing element (11).

9. Device (1) according to claim 7 or 8, characterized in that the heating element (6) has a carrier layer which forms a mechanical protection.

10. Device (1) according to one of claims 7 to 9, characterized in that at least one temperature sensor (15, 16, 17, 18) is integrated in the heating element (6).

11. Device (1) according to one of claims 7 to 10, characterized in that the heating element (6) has a cover layer (22) which at the same time is designed for heat insulation.

12. Device (1) according to one of claims 7 to 11, characterized in that the device (1) has a second covering element (14) for heat insulation.
